(19) United States
(12) Patent Application Publication
(10) Pub. No.: US 2006/0239797 A1
(43) Pub. Date: Oct. 26, 2006

(54) Pre-formed elastomeric fastener adhesive device and method of installation

(76) Inventor: Michael S. Evanbar, Torrance, CA (US)

Correspondence Address: IRVING KESCHNER, 21535 HAWTHORNE BOULEVARD, SUITE 385, TORRANCE, CA, 90503, US

(21) Appl. No.: 11/257,629

(22) Filed: Oct. 25, 2005

Related U.S. Application Data
(60) Provisional application No. 60/673,124, filed on Apr. 20, 2005.

(51) Int. Cl. F16B 43/02

(52) U.S. Cl. 411/542

(57) ABSTRACT

A sheet of deformable adhesive sealant material having a release material formed thereon, a plurality of pre-cut shaped members of different diameters being formed in the sheet. A user drills a bolt or screw hole into parts to be attached for the selected fastener and the surfaces to be attached are then cleaned and dried. The user then removes a selected shaped member from a release sheet and applies it to the part over the hole and pushes the fastener through a centering cut formed on the shaped member into the part to be attached. The fastener becomes coated with rubber adhesive sealant when pushed through the shaped member and, as a result, the sealant coats the fastener threads while at the same time being embedded under the fastener head.

### RELATED APPLICATIONS

This application is based on Provisional Application No. 60/673,124, filed Apr. 20, 2005.

### BACKGROUND OF THE INVENTION

1. Field of the Invention

The present invention provides a pre-formed elastomeric adhesive sealant device for use with fasteners whereby the device provides both a fastener seal and a vibration resistant thread lock connection.

2. Description of the Prior Art

Those that have attempted to thread a nut onto a bolt with one hand can attest to the manual dexterity required. Holding a washer on the bolt while attempting to thread the nut is even more difficult and frustrating. To obtain a weather and moisture-resistant seal, prior to threading requires application of sealant to the contact surfaces before tightening the connection. Moreover, the durability and effectiveness of the seal depends largely on the skill and experience of the user applying the sealant. If, in addition, a vibration-resistant connection is important, a thread-locking product must also be applied to the threads before using. If dissimilar metals are being used, the contact surfaces must be isolated with a dielectric layer of material to prevent the onset of galvanic corrosion.

The requirements noted may require the application of the separate materials to the fastener to provide the desired results.

U.S. Pat. No. 6,086,972 to Rayburn et al discloses a fastener cover in the form of a deformable flat disk having an adhesive sealant on its bottom surface which is deformed over the fastener head with a special tool that encapsulates the fastener head and the radially surrounding surface to create a seal.

Although the fastener cover disclosed in the '972 patent covers the fastener head, the sealant does not penetrate and embed, or coat, the fastener threads thus failing to provide, by itself, a vibration resistant thread locked connection. In addition, a separate dielectric isolation coating is necessary on the threads if a dissimilar metal connection is desired. Further, it is difficult to remove the fastener after installation if required. Finally, the sealant installation described in the '972 patent requires special tooling which increases the overall cost and complexity of the system.

What is desired is to provide a single fastener sealant material which seals the fastener, a vibration-resistant thread lock and an improved corrosion-resistant dielectric coating for dissimilar metal connections.

### SUMMARY OF THE INVENTION

The present invention provides a sheet of deformable adhesive sealant material laminated to a pressure-sensitive adhesive having a release material formed thereon, a plurality of circular pre-cut disk shaped members of different diameters being formed in the sheet. Alternately, the disks are permanently attached to the fastener when the fastener is manufactured. A user drills a bolt or screw hole into parts to be attached for the selected fastener and the surfaces to be attached are then cleaned and dried. For the user-applied device, the selected disk shaped member is removed from a release sheet and applied to the part over the hole and the fastener is pushed through centered cuts formed on the disk shaped member into the part to be attached. The fastener becomes coated with rubber adhesive sealant when pushed through the disk shaped member and, as a result, the sealant coats the fastener threads while at the same time being embedded under the fastener head. The fastener can be removed or re-tightened easily if necessary because the sealant remains flexible.

The sealant device of the present invention provides:

1. The capability to pre-position and “hold” the fastener in place on the parts to be connected while the connection is being completed and secured;

2. A moisture and weather-resistant long-lasting seal for the completed connection;

3. A vibration-resistant thread locked connected for selected fastener;

4. An improved corrison-resistant dielectric insulation, or isolation for dissimilar metal connections; and

5. The capability to re-tighten, remove and/or re-use the connection hardware and components.

The device of the present invention is designed to work with any fastener or fastener component that employs surface-to-surface contact in compression to effect and secure the connection. Fasteners of this type include but are not limited to the following:

1. Washers manufactured from any material, size and shape;

2. Bolts manufactured from any material and in any size or configuration;

3. Nuts manufactured from any material and in any size or configuration;

4. Screws manufactured from any material and in any size or configuration; and

5. Nails manufactured from any material and in any size or configuration; and

6. Rivets manufactured from any material and in any size and configuration.

The device comprises two types; (1) the user-applied device is packaged for application directly to the fasteners or components at the work site at the time of use and (2) the fastener-bonded device permanently attached to the fasteners during the production process. In the latter application, the device becomes an integral part of the fastener itself.

The device of the present invention thus provides a simple and cost effective technique for sealing, providing a vibration-resistant thread locked connection and an improved corrosion-resistant dielectric isolation for fasteners.

### DESCRIPTION OF THE DRAWINGS

For a better understanding of the present invention as well as other objects and further features thereof, reference is made to the following description which is to be read in conjunction with the accompanying drawing therein:

FIG. 1 is a perspective view of a sheet having a plurality of shaped elastomeric devices of the present invention formed therein;

FIG. 2 is a cross-section along 2-2 of FIG. 1;

FIG. 3(a)-3(f) illustrate the steps for installing a threaded fastener using the device of the present invention;

FIGS. 4(a)-4(b) illustrate an installed screw using the device of the present invention; and

FIGS. 5(a)-5(c) illustrate the sealant of the present invention formed as an integral part of a washer.

### DESCRIPTION OF THE INVENTION

In a first embodiment of the present invention the sealant device 10 of the present invention is attached directly to fastening devices or to the parts being connected to the work site.

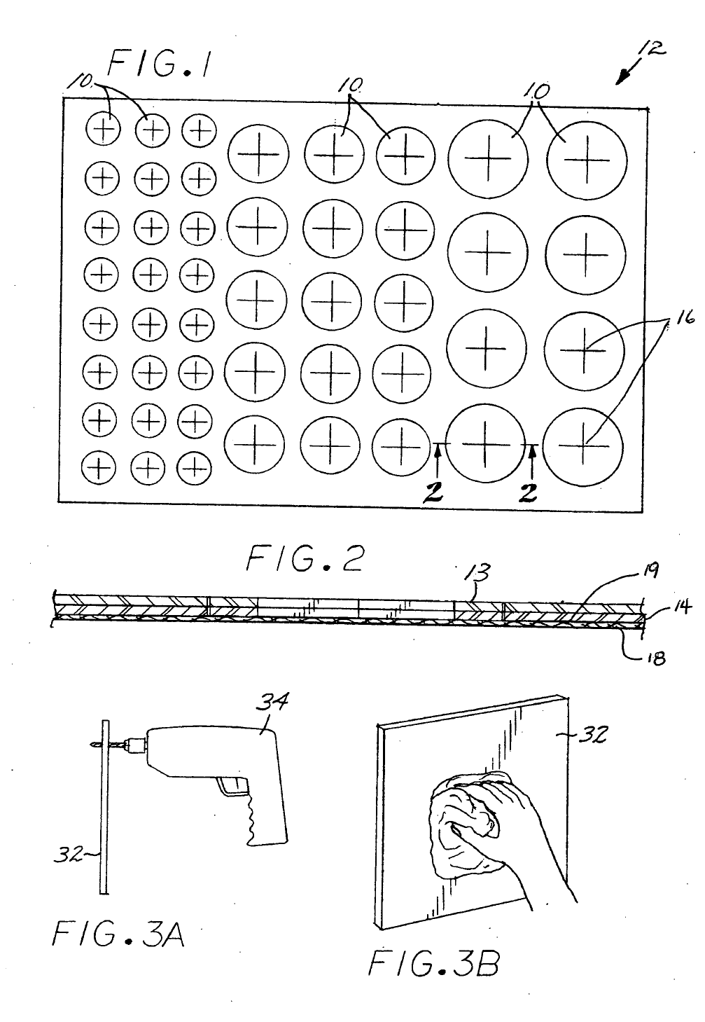

Referring to FIGS. 1 and 2, the sealant device 10 is a pre-formed elastomeric wafer preferably formed as part of a sheet 12 having a plurality of such devices shaped as annular disks of different diameters to match standard fastener and washer sizes. The device 10 preferably comprises a laminate formed of elastomeric layer 13 and adhesive layer 14, a central cut opening 16 being formed in layers 13 and 14 through which a bolt or screw is passed in use (although the preferred shape is the annular disk shown in the figure, other shapes can be utilized). The user applied device 10 may be attached directly to fasteners or to the parts being connected at the work site as will be described hereinafter. As noted hereinabove, devices 10 preferably are packaged on sheets of “lift-off” non-stick backing film 18 (poly release liners or the equivalent). The advantage of using self-curing elastomeric material to form device 10 are:
1. The uncured elastomer flows under compression, filing and sealing any surface or other voids that may exist between the washer, fastener or attached part.
2. Self-curing elastomers laminated to pressure-sensitive adhesives have the capacity to lock fastener and fastener components in place for easy assembly and subsequently cure to a vibration and weather-proof seal.
3. Prior to full cure, the fasteners may be re-tightened without breaking the seal. Completely cured fasteners may be completely removed and re-used.

The preferred elastomeric adhesive coating material is EPDM, a pressure-sensitive elastoform flashing widely used to seal pipes, scuppers, and other roof system structures and penetrations. EPDM (ethylene-propylene diene monomer) layer 13 is a synthetic rubber typically used for elastoform flashing, is laminated to a cured synthetic rubber pressure-sensitive adhesive 14, such as butyl. The flashing is typically produced in sheets or rolls of material that the user cuts to size on the work-site. Typical properties and characteristics of EDPM flashing include malleability, brittle resistance to temperature variation, ozone and ultra-violet exposure, and self-curing capability which meet the requirements of the present invention. Other elastomeric materials which could be utilized include synthetic fabrics, such as neoprene and plastics, such as polyeurothane. The elastomeric coating is non-conductive and thus provides a corrosion resistant feature. Since the EPDM laminate has an adhesive layer 14, release sheet 18 need not have an adhesive.

Although the combined elastomeric laminate thickness typically ranges from about 40 mils to about 140 mils (the adhesive layer thickness is in the range from about 15 mils to about 40 mils), practical upper ranges are determined by the amount of sealant needed for a particular fastener, i.e. larger diameter fasteners require thicker layers. The thickness of release sheet 18 typically ranges from about 2 to about 10 mils.

It should be noted that EDPM by itself has no adhesive properties (it is just a stretchy piece of rubber). In order for device 10 to function, it is necessary to bond an adhesive layer to the EDPM layer. Butyl is preferred as the adhesive layer because it is a fully-cured rubber adhesive that remains flexible indefinitely and does not harden when exposed to heat or UV. Other adhesives can be utilized as long as they are fully-cured, non-hardening rubber with a base similar to butyl. After cutting the devices and the centered cross-cuts, the two-layer device would be ready to use, if it were not necessary to package and store the device. In order to prevent the device or laminate (layers 13 and 14) 10 from sticking to the packaging and becoming unusable, liner 18 is pressed against the adhesive side of the device 10. Line 18 has no adhesive, but forms an easily peeled-off protector for the adhesive layer 14 until ready to use.

The laminate design is necessary regardless of the elastomeric selected since only one side of device 10 can be adhesive and a means of temporarily protecting the adhesive layer 14 from the packaging, such as the non-stick poly liner, or layer, 18 is necessary.

It should be noted that although FIG. 1 illustrates a plurality of devices 10 having different diameters formed in sheet 12, a sheet having a plurality of devices 10 of the same diameter may also be utilized in accordance with the teachings of the present invention.

The centered cross-cuts 16 on the device 10 are necessary to prevent the device 10 from rupturing when fasteners are pushed against the material. Although the figures illustrate cross-shaped cuts 16, other shaped cross-cuts can also be utilized.

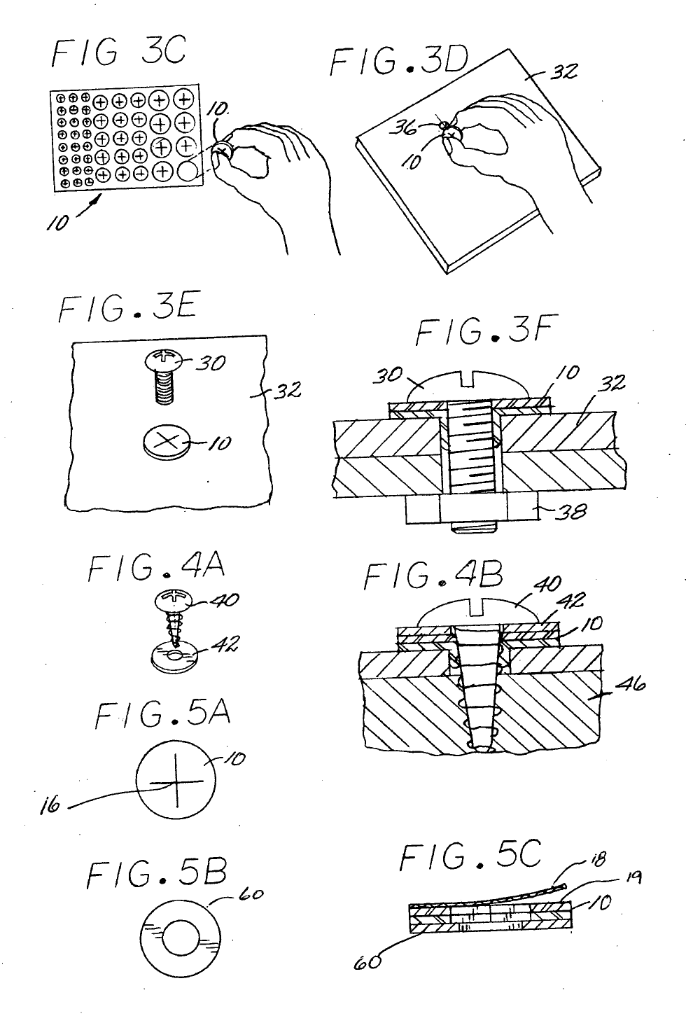

Referring now to FIGS. 3(a)-3(f), the process of installing a fastener, such as threaded bolt 30, is illustrated. A hole is formed in part 32 using a device, such as drill 34. The surface of part 32 is then cleaned and dried. A selected device 10 is then peeled from release layer 18 and then positioned over hole 36 formed in part 32 (the diameter of device 10 exceeds the diameter of hole 36). The fastener 30 is then pushed through the device 10 through cross-cut 16 and then tightened with respect to nut 38. The fastener 30 is tightened by hand or any suitable tool, such as a screw driver, hammer or wrench, the only requirement being that sufficient compression be applied to device 10 (and maintained) to force sealant into hole 36 and fill voids between the fastener 30 and part 32 and thus seal the connection. With a threaded fastener, sufficient compression is typically achieved with the use of a nut, crimped washer or other threaded component. The fastener thread diameter determines the smallest size of device 10 that can be used because the centered cross-cut formed 16 in device 10 must be large enough to accept the fastener. If the hole is oversized relative to the fastener device such that device 10 accepts the fastener but will not cover the holes, a device 10 having a larger diameter must be selected. A larger than needed diameter will not impair the effectiveness of the sealant process.

FIGS. 4(a) and 4(b) illustrate a screw 40 and washer 42 installed in part 46 through device 10.

For use with bolt type fasteners, a desired diameter size device 10 is selected and peeled off the poly release liner 18 at the time of use, exposing the pressure-sensitive adhesive surface 19. The user attaches the device directly to the part itself (over the bolt hole). A smaller sized device also may be attached directly to the contact surface of the bolt head. The bolt is passed through the backing washer first (if used) and then through the hole. As the bolt is passed through the device, both threads and bolt hole are coated with elastomeric adhesive material. The elastomeric grips and immobilizes both the backing washer and the bolt itself so that the nut can be threaded over the bolt and secured without holding the bolt. As the nut is advanced over the elastomer-coated bolt threads, it is thread-locked. When the nut is fully advanced and tightened, the elastomeric is forced into surface or other voids that may exist between the washer, bolt and hole for a permanent weather and vibration-proof seal. The entire operation may be easily performed with one hand, and with the surface in any orientation.

For use with washers, a device 10 of a size smaller than the washer diameter is selected and peeled off the poly release liner at the time of use, exposing the pressure-sensitive adhesive surface. The user applies the device directly to the part to be attached over the fastener hole. Alternatively, the device may be attached to the washer (face-down side). As the fastener is passed through the washer, the seal surface and fastener are coated with elastomeric adhesive. When the fastener is tightened, the elastomeric is forced into surface or other voids that may exist between the washer and part for a permanent weather and vibration-proof seal.

For use with screws, a device 10 of the desired size is selected and peeled off the poly release liner exposing a pressure-sensitive adhesive surface. The user attaches the device directly to the part itself (over the pre-drilled hole). A smaller sized device also may be attached directly to the contact surface of the screw head. The screw is passed through the backing washer (if used) and then positioned over the pre-drilled hole. As the screw is advanced through the device and hole, both are coated with the elastomeric material. When the screw is securely tightened and seated, the elastomeric material is forced into any surface or other voids that may exist between the part, screw and hole, permanently locking the screw (and washer if used) in place and effecting a weather-proof, long-term seal.

For use with nails, a device 10 of the desired size is selected and peeled off the poly release liner exposing the pressure-sensitive adhesive surface. The user positions the device on the part where the nail is to be driven as a mark. Alternatively, a smaller sized device also may be attached directly to the contact surface of the nail head, or the user may attach the device to the face-down side of a backing washer, for extra security. As the nail is driven into the part through the device, both are coated with the elastomeric material. When the nail is fully driven and seated, the elastomeric material in the device fills any surface or other voids that may exist between the nail and part, permanently locking the nail in place and effecting a weather-proof, long-term bond between nail and part.

In a second embodiment, the annular shaped ring device is comprised of single-sided pressure-sensitive adhesive material bonded to the fastener during production. Fastener-bonded devices are permanently attached to a variety of standard sized bolts, screws and washers during the manufacturing process.

The bolt-bonded device comprises an adhesive annulus shaped material bonded to the inside of the bolt head with a pressure-sensitive adhesive backing protected until use with “peel-off” poly release liner film.

The washer-bonded device comprises and adhesive annulus shaped material bonded to one side of the washer with a pressure-sensitive adhesive backing protected until use with “peel-off” film.

The screw-bonded device comprises and adhesive annulus shaped material bonded to the inside of the screw head with a pressure-sensitive adhesive backing protected until use with “peel-off” film.

The fastener-bonded device bolt, screw and washer are used as described above except that the user need not apply the device to the fastener because both are pre-bonded as part of the production process.

For the fastener-bonded version of the device, a flexible pressure sensitive adhesive material is bonded to the back side of the washer, screw or bolt head during the fastener production phase and forms an integral part of the fastener system. For the user-applied version of the device, a flexible pressure-sensitive adhesive material is packaged for attachment to the fastener or parts at the work site.

For both versions, the device's elastomeric immobilizes the fastener or fastener component and spreads out laterally when compressed between the fastener and the attached surface to fill uneven surface contours and voids between surface and attach hardware. This specific behavior of the device under compression provides unique benefits to the attachment not otherwise provided:

1. The sealing capacity of the device material under compression obviates the need for additional rubber washers and/or sealants to affect a weather-resistant seal.

2. Elastomer spreads over fastener surfaces at the time of use, acting to lock the fastener components (bolt, nut, screw) in place, and obviating the need for products intended to prevent loosening of the fasteners.

3. Elastomer spreads over fastener and part surfaces at the time of use, improving the corrosive resistance and dielectric properties of the connection and connection hardware.

4. The device's pressure sensitive adhesive qualities enables the user to easily pre-position the fastener components in hard-to-reach areas and in difficult orientations, even upside down.

5. The device remains flexible throughout the life of the seal. If, for any reason, the seal fails, the fastener can be re-tightened or the device replaced.

Weather resistant pressure-sensitive adhesive backing materials suitable for use with the devices include but are not limited to self-curing elastomers, or elastomer-embedded Ethylene Propylene Diene Monomer (EPDM) flashing, commonly used to implement roof repairs. The pressure sensitive adhesive backing can be protected until use by a strip-off plastic film.

The device design and material selection obviates the need for rubber washers or sealants to protect against moisture penetration through the washer and/or rust-out of the attached hardware itself.

1. The fastener-bonded and user-applied devices may be used with any type of bolt, washer or screw fastener material. The device will bond to stainless steel or chrome/cadmium-plated metals, as well as non-metal material such as plastics and woods.

2. The fastener-bonded device is permanently bonded to the fastener during manufacture, whereas the user-applied version is attached to the fastener at the work site. Although any suitable elastomeric material may be used for both versions of device, a self-curing synthetic rubber elastomeric or elastomer-embedded EPDM is the preferred choice. The devices of the present invention are designed to fit snugly around the fastener. For this reason, the devices are provided with centered slotted cutouts to accommodate variable size fasteners.

3. The elastomeric adhesive is preferably covered until use with a peel-off poly release liner to protect and preserve the adhesive until used.

4. If a self-curing adhesive backing is used with the system, the adhesive will cure with age to form a permanent, waterproof seal. A lighter duty adhesive backing may be used for indoor or protected environments.

5. As an alternate design feature, the device incorporates a washer made from plastic, metal or other suitable material, bonded to the outer (non-adhesive) surface of the disk. This design feature will facilitate the tightening of screw and bolt fasteners providing a sliding surface contact between fastener head and device.

FIGS. 5(a)-5(c) illustrate how the device 10 of the present invention is an integral part of a fastener system. In particular, FIG. 5(a) illustrates device 10, FIG. 5(b) illustrates a conventional washer 60 and FIG. 5(c) illustrates device 10 bonded to washer 60 with adhesive surface of disk 10 in the process of being peeled of backing layer 18.

The devices 10 of the present invention temporarily immobilizes and pre-positions fasteners and components until the connection is secured. Unlike the polymeric application shown in Publication No. US2004/0228998, published on Nov. 18, 2004, the bond provided by device 10 remains flexible for the duration of the seal and enables fasteners to be re-positioned or re-used, and if necessary, re-tightened.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A sheet of elastomeric deformable material having first and second flat planar disks formed therein, said first and second disks each having first and second surfaces, a layer of release material covering said first surface of said first and second disks, said first planar disk having a diameter different than the diameter of said second planar disk, and a cut portion formed on the second surface of said first and second planar disks.

2. The sheet of claim 1 wherein said first and second planar disks comprise EDPM.

3. The method of applying a seal to a fastener coupled to a part comprising the steps of:
forming a hole in said part;
providing a sheet comprising a layer of elastomeric deformable material and an adhesive layer in contact with said elastomeric material, said sheet having first and second shaped members each having first and second surfaces formed therein;
a layer of release material being in contact with said first surface of each of said first and second shaped members;
removing said first shaped member from said release sheet and applying said first shaped member over said hole; and
inserting said fastener through said first shaped member and into said part.

4. The method of claim 3 wherein the diameter of said first shaped member is different than the diameter of said second shaped member.

5. The method of claim 4 wherein said deformable material is EDPM.

6. The method of claim 3 wherein a cut portion is formed in the second surface of said first shaped member, said fastener being inserted through said cut portion into said part.
